(19) United States
(12) Patent Application Publication
(10) Pub. No.: US 2012/0206541 A1
(43) Pub. Date: Aug. 16, 2012

(54) Spectacle Lens Marking Method

(75) Inventor: Tomohiro KUMAGAI, Matsumoto-shi (JP)

(73) Assignee: SEIKO EPSON CORPORATION, Tokyo (JP)

(21) Appl. No.: 13/372,289

(22) Filed: Feb. 13, 2012

(30) Foreign Application Priority Data
Feb. 14, 2011 (JP) 2011-028411

(51) Int. Cl. B41J 2/04

(52) U.S. Cl. 347/51

(57) ABSTRACT

A spectacle lens marking method includes: ejecting a first ink drop of ultraviolet curable ink from a nozzle by ink jet system onto a surface of a water-repellent layer provided on the surface of the spectacle lens; and hardening the first ink drop by applying ultraviolet light to the first ink drop.

### CROSS-REFERENCE

This application claims priority to Japanese Patent Application No. 2011-028411, filed Feb. 14, 2011, the entirety of which is hereby incorporated by reference.

### BACKGROUND

1. Technical Field

The present invention relates to a spectacle lens marking method.

2. Related Art

A typical spectacle lens has a mark put on the surface of the lens as a reference used when cutting of the frame shape, attachment of the lens to the frame, or other processing is carried out. This mark indicates a fitting point, a dioptric power measurement point, left-right identification information, or the like.

The mark of the spectacle lens is produced thereon by stamping, for example. According to a known marking method using stamping, ink filling a concave of a printing plate is transferred to the surface of a printing pad. Then, the printing pad having received the ink is pressed against the surface of the spectacle lens so that the ink on the surface of the printing pad can be transferred to the surface of the spectacle lens as a mark on the spectacle lens.

According to this marking method using the stamping system in the related art, the following problems have been arising. The printing plate needs to be replaced with other plates even for the same type of spectacle lens when different marks are required for different customers or designations. Moreover, the printing plate needs to be switched every time the type of spectacle lens is changed. Furthermore, a larger number of marking devices are required as the variety of the types of spectacle lens increases, which raises the manufacturing cost.

For overcoming these drawbacks, an ink jet system proposed as a marking method in each of JP-A-2005-313548, JP-A-2003-145747, and JP-A-2004-347947 eliminates the use of the printing plate, for example. According to the ink-jet-type marking method shown in these references, various marks can be produced by changing ejection patterns used for ejection of ink drops from a nozzle. The ink drops ejected by the ink jet system are drops of thermosettng ink, ultraviolet-curable ink, water-based ink, oil-based ink, or other types of ink. The coloring agent used for the ink jet system is selected from dye, pigment, or other agents.

Recently, a layer having excellent hydrophobic property such as water-repellent film and oil-repellent film has been provided on the surface of the spectacle lens. According to the examples shown in the above references, therefore, ink drops 92 easily flow on a spectacle lens 91 by the water-repellent effect produced on the surface of the spectacle lens 91, wherefore the ink drops 92 easily mix with each other as illustrated in FIG. 14. As a consequence, the large ink drops 92 and the small ink drops 92 are both generated, in which condition wide clearances are produced between the adjoining ink drops 92. In this case, the shape of a mark 93 is deformed and therefore cannot be easily recognized as an appropriate shape of the mark 93.

### SUMMARY

An advantage of some aspects of the invention is to provide a spectacle lens marking method capable of producing a mark recognizable on the spectacle lens in a preferable condition.

A spectacle lens marking method according to an aspect of the invention includes: ejecting a first ink drop of ultraviolet curable ink from a nozzle by ink jet system onto a surface of a water-repellent layer provided on the surface of the spectacle lens to produce a mark; and hardening the first ink drop by applying ultraviolet light to the first ink drop.

According to the method of this aspect of the invention, ultraviolet light applied to the first ink drop hardens the first ink drop, thereby preventing mixture of the first ink drops when the plural first ink drops are ejected. In this case, the shape of the mark is not deformed even when the mark is produced on the water-repellent layer of the spectacle lens. Accordingly, the mark can be recognized in a preferable condition.

Moreover, generation of the large-sized first ink drops is avoided by prevention of mixture between the plural first ink drops. Thus, the mark can be easily wiped off.

Furthermore, in case of the colored first ink drops, the first ink drops not easily mixed with each other can constitute a mark having a desired color.

It is preferable that a plurality of the first ink drops of the aspect of the invention are ejected such that the positions of the first ink drops contacting the surface of the spectacle lens can be separated from each other. In this case, it is preferable that the plurality of the first ink drops ejected on the surface of the lens are hardened before contacting each other.

According to this configuration, the first ink drops are hardened after ejected such that the positions of the first ink drops contacting the surface of the spectacle lens can be separated from each other. Thus, mixture of the first ink drops can be further prevented.

It is preferable that the marking method of the aspect of the invention further includes: ejecting a second ink drop from the nozzle toward a position between the plural hardened first ink drops; and hardening the second ink drop by applying ultraviolet light to the ejected second ink drop.

According to this configuration, the clearances between the first ink drops are filled with the second ink drops additionally ejected toward the spaces between the plural hardened first ink drops. In this case, both the printing densities of the first ink drops and the second ink drops increase. Accordingly, the mark becomes darker and recognizable in a more preferable condition.

It is preferable that the printing density of the first ink drops of the aspect of the invention lies in a range from 360 dpi to 720 dpi.

According to this configuration, the printing density (printing resolution) of the first ink drops increases when set at 360 dpi or higher. In this case, the mark can be easily recognized. On the other hand, when the printing density is 720 dpi or lower, appropriate clearances are produced between the plural first ink drops. In this case, mixture of the plural first ink drops can be prevented. There is a relationship which should be considered between the ink ejection amount and the printing density. When the ejection amount is about 1 ng with the diameter of the contact between the ink drop and the surface of the spectacle lens set at 30 μm, it is preferable that the printing density is 720 dpi. When the ejection amount is about 14 ng with the diameter of the contact between the ink drop and the surface of the spectacle lens set at 70 μm, it is preferable that the printing density is 360 dpi.

It is preferable that the first ink drops of the aspect of the invention are ejected in such a condition that the distance between the nozzle and the surface of the spectacle lens becomes 5 mm or shorter.

When a distance (H) between the nozzle and the surface of the spectacle lens exceeds 5 mm, the first ink drop divides into parts before contacting the surface of the spectacle lens. In this case, there is a possibility that the first ink drop cannot reach a predetermined position on the surface of the spectacle lens and therefore cannot constitute the appropriate shape of the mark.

According to the above configuration, the distance (H) is set at 5 mm or shorter. In this case, the first ink drop does not divide into parts before reaching the surface of the spectacle lens. Accordingly, the mark can be recognized in a more preferable condition.

It is preferable that the surface of the spectacle lens of the aspects of the invention is a curved surface, and that the spectacle lens marking method further includes shifting the nozzle and the spectacle lens relative to each other in the radial direction of the spectacle lens such that the distance between the surface of the spectacle lens and the nozzle becomes uniform.

The distance between the nozzle and the printing position at the center of the surface of the spectacle lens differs from the distance between the nozzle and the printing position at the end of the surface of the spectacle lens. In this case, the size of the first ink drop contacting the surface of the spectacle lens varies according to the printing position, in which condition the shape of the mark easily deforms.

According to the above configuration, the nozzle and the spectacle lens are shifted relative to each other such that the distance between the nozzle and the printing position on the surface of the spectacle lens becomes uniform for the entire area of the surface of the spectacle lens. In this case, the sizes of the first ink drops contacting the surface of the spectacle lens become uniform regardless of the printing positions. Accordingly, the deformation of the shape of the mark can be avoided.

### BRIEF DESCRIPTION OF THE DRAWINGS

The invention will be described with reference to the accompanying drawings, wherein like numbers reference like elements.

FIG. 1 is a plan view illustrating marks printed by a marking method according to a first embodiment of the invention.

FIG. 2 illustrates a part of a marking device which performs the spectacle lens marking method.

FIG. 3 is an enlarged view illustrating a plurality of first ink drops constituting a mark.

FIGS. 4A, 4B, and 4C illustrate flowing conditions of the first ink drops.

FIGS. 5A, 5B, and 5C illustrate the stability of the shape of the first ink drop after ejection.

FIG. 6 illustrates the shape of the mark when the distance between a nozzle and the surface of the spectacle lens is short.

FIG. 7 illustrates the shape of the mark when the distance between the nozzle and the surface of the spectacle lens is long.

FIGS. 8A through 8C illustrate a control step of the marking method.

FIG. 9 illustrates the entire structure of the marking device.

FIGS. 10A and 10B illustrate a spectacle lens marking method according to a second embodiment.

FIG. 11 illustrates first ink drops constituting a mark printed according to an example 1.

FIG. 12 illustrates first ink drops constituting a mark printed according to an example 2.

FIG. 13 illustrates first ink drops and second ink drops constituting a mark printed according to an example 3.

FIG. 14 illustrates a condition in which plural ink drops are mixed with each other according to a related art.

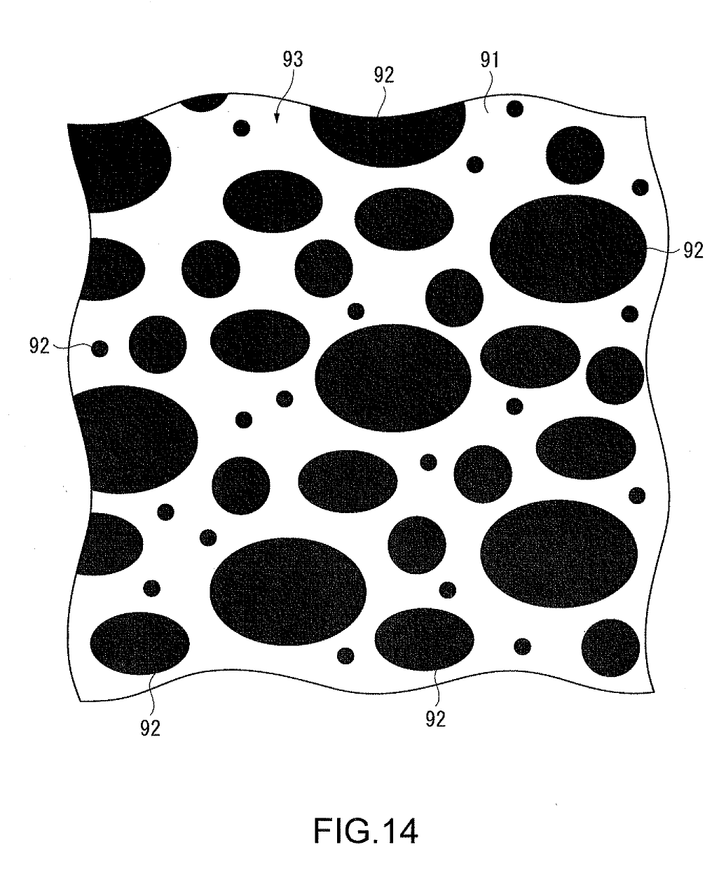

### DESCRIPTION OF EXEMPLARY EMBODIMENTS

### First Embodiment

A spectacle lens marking method (abbreviated as a marking method in some cases) according to a first embodiment of the invention is hereinafter described.

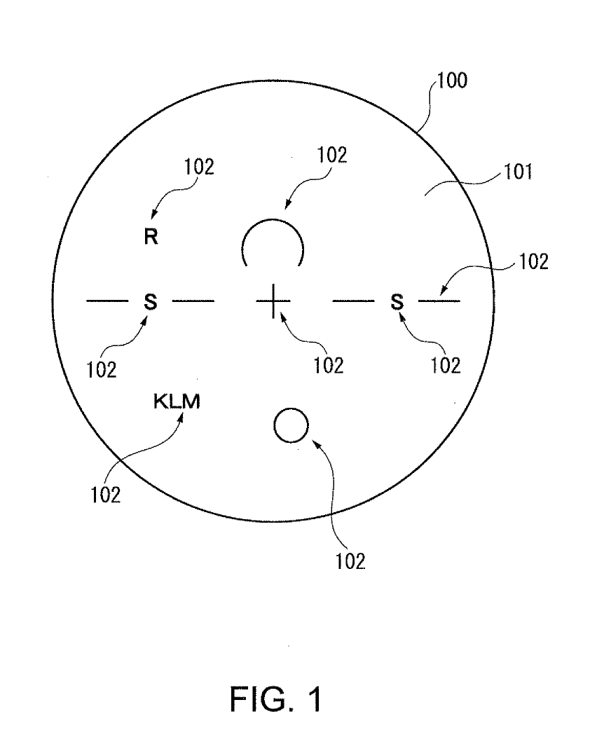

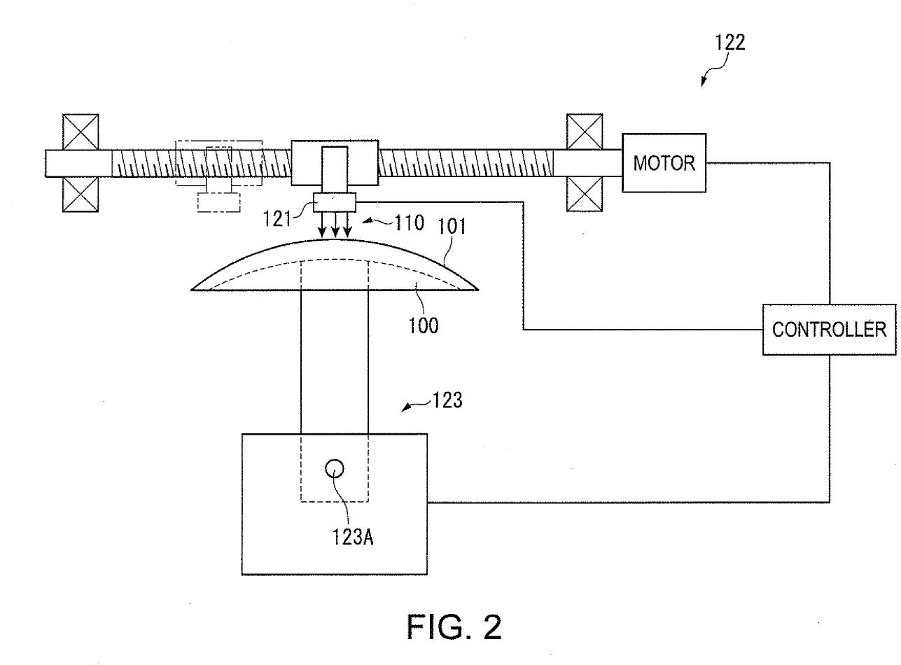

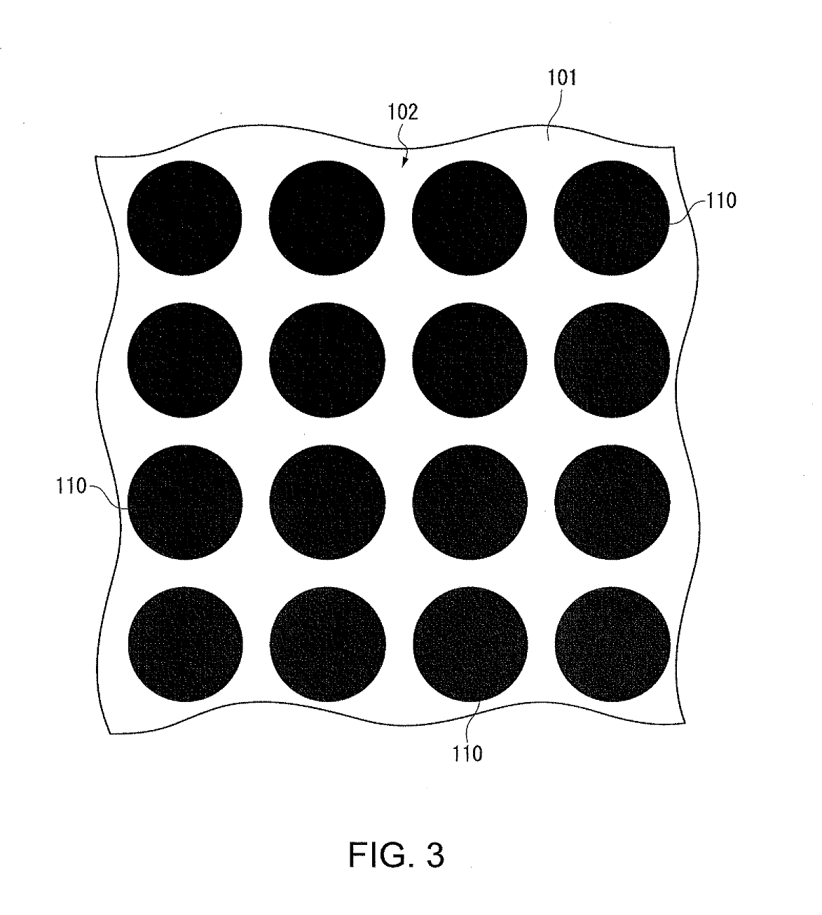

FIG. 1 illustrates various types of marks printed by the marking method. FIG. 2 illustrates the general structure of a marking device. FIG. 3 is an enlarged view illustrating a plurality of first ink drops constituting the mark.

As illustrated in FIGS. 1 through 3, the marking method according to the first embodiment is a method for printing the marks 102 on a surface 101 of a spectacle lens 100 by using ink jet system.

The ink jet system is a method which ejects small first drops 110 from a nozzle 121 having small openings. The ink jet system uses piezoelectric system, thermal system, or other systems.

The spectacle lens 100 is a progressive-multifocal lens having the curved surface 101. A water-repellent layer is provided on the surface 101 of the spectacle lens 100. This water-repellent layer is constituted by a water-repellent film or an oil-repellent film.

The marks 102 indicate a fitting point, a dioptric power measurement point, left-right identification information, and others to be used as reference when cutting of the frame shape, attachment of the lens to the frame, or other processing is carried out.

As illustrated in FIG. 3, each of the marks 102 is constituted by the plural first ink drops 110. The first ink drops 110 are drops of ultraviolet curable ink. The first ink drops 110 may contain pigment, dye or other agents, that is, may be constituted by colored ink drops.

Specific steps of the marking method in the first embodiment include an ejecting step for ejecting the first ink drops 110 toward the surface 101 of the spectacle lens 100, a hardening step for applying ultraviolet light to the plural first ink drops 110 ejected onto the surface 101 to harden the first ink drops 110, and a control step for controlling the inclination and other conditions of the spectacle lens 100.

As illustrated in FIG. 2, the marking method in this embodiment uses a nozzle 121, a driving unit 122 which reciprocates the nozzle 121, a not-shown ultraviolet irradiator, and a holder 123 for marking. The operations of the nozzle 121 and other components are controlled by a controller.

### Ejecting Step

As illustrated in FIG. 2, the ejecting step ejects the plural first ink drops 110 from the nozzle 121 to produce the marks 102 on the surface 101 of the spectacle lens 100.

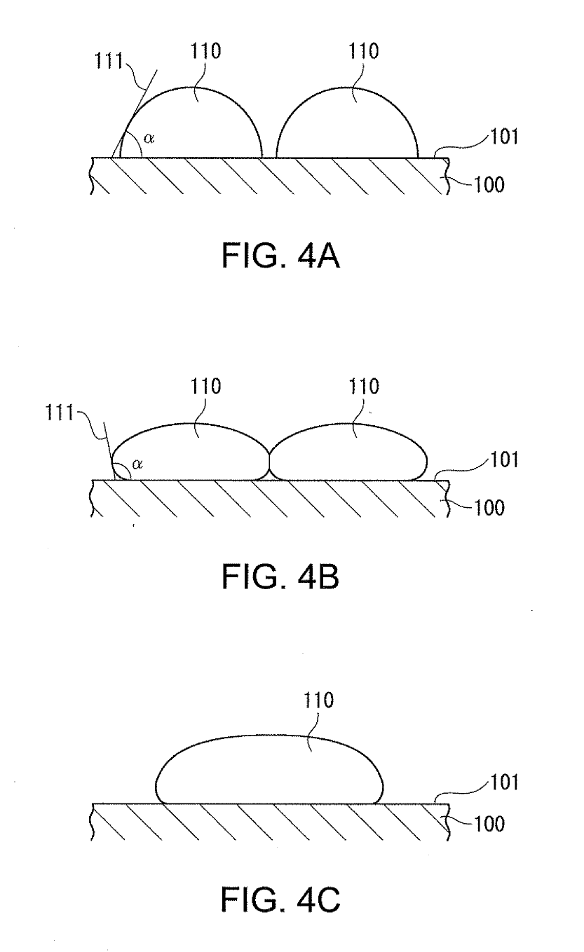

As illustrated in FIG. 3, it is preferable that the ejecting step ejects the plural first ink drops 110 such that the positions of the ink drops 110 contacting the surface 101 can be separated away from each other. The specific actions of the plural first ink drops 110 ejected such that their positions contacting the surface 101 can be separated from each other are now explained with reference to FIGS. 4A through 4C. FIGS. 4A through 4C illustrate flow conditions of the first ink drops 110.

As can be seen from FIG. 4A, the adjoining first ink drops 110 are not mixed with each other immediately after ejection toward the surface 101 of the spectacle lens 100 such that their positions contacting the surface 101 can be separated away from each other.

However, since the water-repellent layer is provided on the surface 101 of the spectacle lens 100, a contact angle α formed by a tangential line 111 of the corresponding first ink drop 110 and the surface 101 of the spectacle lens 100 gradually increases with an elapse of time as illustrated in FIG. 4B. In this condition, the first ink drops 110 flow and come to contact each other. As a result, the adjoining first ink drops 110 start mixing with each other as illustrated in FIG. 4C, thereby deforming the shape of the mark 102. Therefore, it is preferable that the hardening step described later hardens the plural first ink drops 110 before they contact each other.

It is preferable that the ejecting step is performed only once. In other words, it is preferable that the additional first ink drops 110 to overlap with the first ink drops 110 hardened on the surface 101 of the spectacle lens 100 are not ejected. When the additional first ink drops 110 are overlapped, the marks 102 become darker. However, the marks 102 darkened in this manner are difficult to be wiped off. Therefore, the additional first ink drops 110 may be overlapped only in such a case that the marks 102 can be wiped off relatively easily.

It is preferable that the printing density of the first ink drops 110 in the ejecting step lies in a range from 360 dpi to 720 dpi.

When the printing density of the first ink drops 110 is 360 dpi or higher, the marks 102 can be easily recognized.

On the other hand, when the printing density of the first ink drops 110 is 720 dpi or lower, clearances having appropriate sizes can be produced between the adjoining first ink drops 110. In this case, mixture of the first ink drops 110 can be decreased.

It is preferable that the first ink drops 110 ejected in the ejecting step have small sizes. For example, printing with the printing density of 720 dpi produces the first ink drops 110 smaller than those of printing with the printing density of 360 dpi, and is thus advantageous. However, the clearances between the adjoining first ink drops 110 produced by printing with the printing density of 720 dpi become narrower than the corresponding clearances of printing with the printing density of 360 dpi. In this case, the probability of mixture between the first ink drops 110 increases.

For lowering the risk of mixture of the first ink drops 110, and also for reducing the sizes of the ink drops 110, the following method can be employed.

The method capable of achieving these advantages uses the nozzle 121 which corresponds to the printing density of 720 dpi but has been modified such that the printing density becomes 360 dpi. This modified type of the nozzle 121 having the printing density of 360 dpi is manufactured by closing the half number of the openings formed on the nozzle 121 having the printing density of 720 dpi. This modified nozzle 121 provides the printing density of 360 dpi in appearance, but has the structure of the nozzle 121 for 720 dpi. Thus, the sizes of the first ink drops 110 ejected from the modified nozzle 121 become smaller than the sizes of the first ink drops 110 ejected from the nozzle 121 for 360 dpi.

Alternatively, the adjacent first ink drops 110 may be ejected onto the surface 101 of the spectacle lens 100 with a pitch of 360 dpi but by the ink amount corresponding to the printing density of 720 dpi so that clearances can be produced between the adjoining first ink drops 110.

In the ejecting step, it is preferable that a distance (H) between the nozzle 121 and the surface 101 of the spectacle lens 100 is 5 mm or shorter.

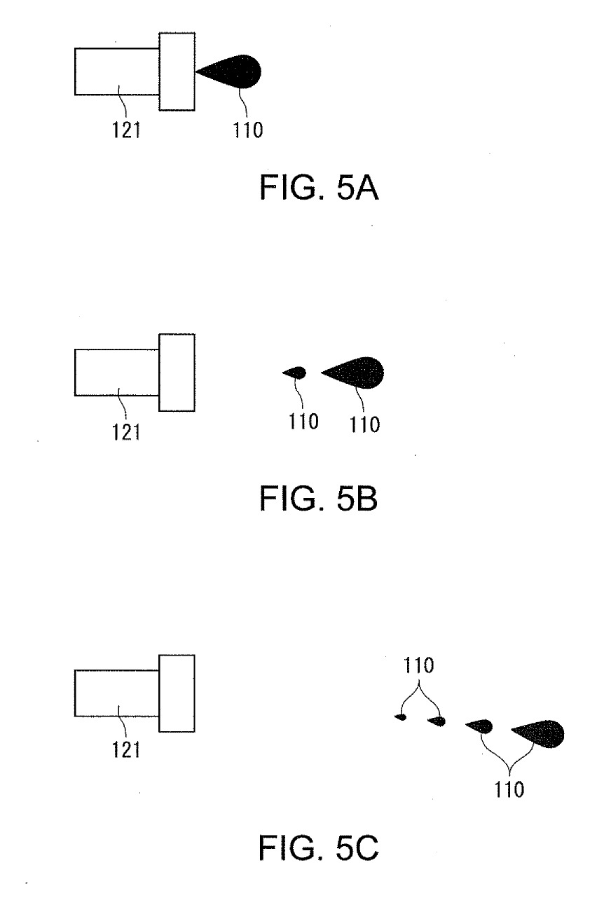

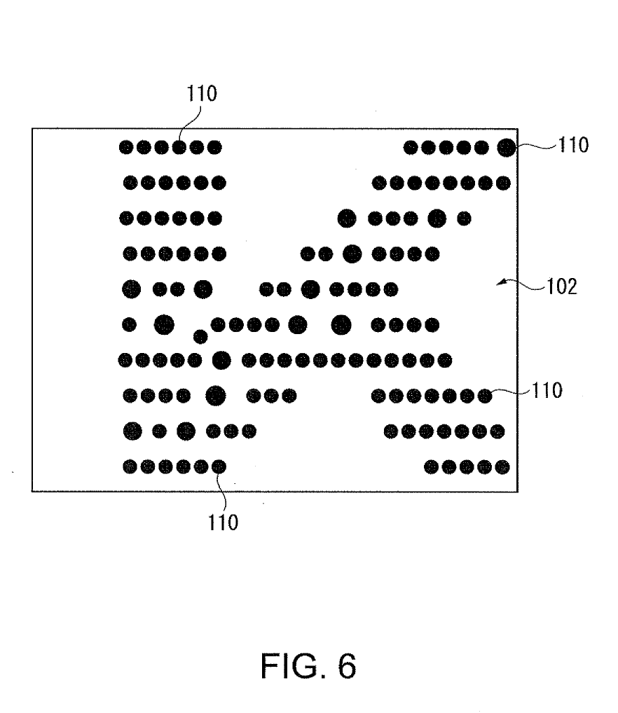

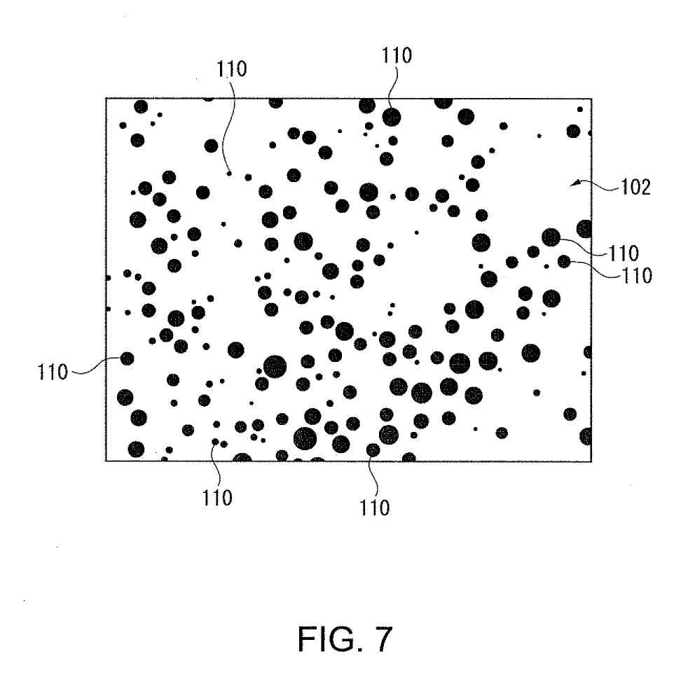

The specific relationship between the distance (H) and the stability of the shapes of the ejected first ink drops 110 is now explained with reference to FIGS. 5A through 7. FIGS. 5A through 5C illustrate the stability of the shape of the ejected first ink drop. FIG. 6 illustrates the shape of the mark produced when the distance between the nozzle 121 and the surface 101 of the spectacle lens 100 is short. FIG. 7 illustrates the shape of the mark produced when the distance between the nozzle 121 and the surface 101 of the spectacle lens 100 is long.

As can be seen from FIGS. 5A and 5B, the first ink drop 110 is stabilized substantially with no separation into parts immediately after ejection from the nozzle 121 or at a position close to the nozzle 121. In these cases, the distance (H) is only 5 mm or shorter, in which condition the shape of the mark 102 does not deform and thus is easily recognizable as illustrated in FIG. 6.

On the other hand, when the first ink drop 110 is ejected to a position far away from the nozzle 121, the first ink drop 110 is divided into small drop parts. In this case, the ejection direction of the first ink drop 110 becomes unstable and difficult to contact a predetermined position as illustrated in FIG. 7. As a result, the shape of the mark 102 deforms and becomes difficult to be recognized.

When the distance between the nozzle 121 and the surface 101 of the spectacle lens 100 is long, the shapes of the first ink drops 110 can be stabilized by supplying a larger amount of ink per one drop of the first ink drops 110.

### Hardening Step

In the hardening step, ultraviolet light is applied from the not-shown ultraviolet irradiator to the plural first ink drops 110 to harden the first ink drops 110. This step lowers fluidity of the plural first ink drops 110, that is, produces a condition in which the plural first ink drops 110 are not repelled from the surface 101 of the spectacle lens 100. Accordingly, this step can reduce mixture between the plural first ink drops 110, and thus can prevent deformation of the shapes of the marks 102.

As noted above, it is preferable that the hardening step hardens the plural first ink drops 110 before they contact each other.

The ultraviolet light may be applied to the surface 101 of the spectacle lens 100 after completion of ejection of the first ink drops 110 to the entire area of the surface 101, or may be applied to the surface 101 of the spectacle lens 100 during ejection of the first ink drops 110 thereto.

### Control Step

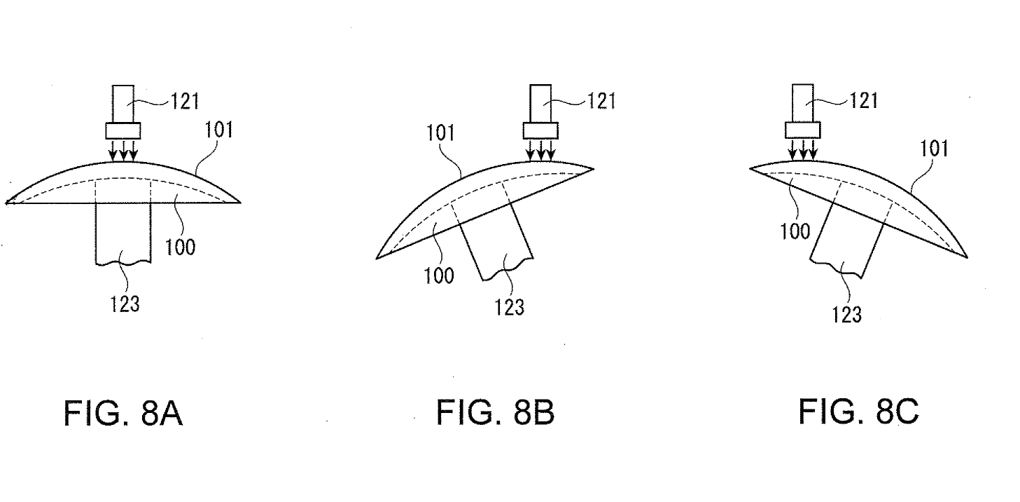

The control step is now explained with reference to FIGS. 8A through 8C which illustrate the details of the control step.

It is obvious that the distance between the nozzle 121 and the printing position located at the center of the surface 101 of the spectacle lens 100 differs from the distance between the nozzle 121 and the printing position located at the end of the surface 101. These variations in the distance between the nozzle 121 and the surface 101 of the spectacle lens 100 lead to variations in the sizes of the ink drops 110 contacting the surface 101 of the spectacle lens 100 for each position, whereby the shapes of the marks 102 easily deform (see FIGS. 5A through 7).

For solving this problem, the control step shifts the nozzle 121 and the spectacle lens 100 relative to each other in the radial direction of the spectacle lens 100 such that the distance between the surface 101 of the spectacle lens 100 and the nozzle 121 becomes uniform.

For example, it is preferable that the control step rotates the spectacle lens 100 by using an oscillating mechanism of the holder 123 such that the distance between the surface 101 of the spectacle lens 100 and the nozzle 121 becomes uniform as illustrated in FIGS. 2 and 8A through 8C. The spectacle lens 100 rotates around a shaft 123A passing through the center of curvature of the spectacle lens 100.

More specifically, when the printing position is located at the center of the spectacle lens 100, the spectacle lens 100 is held without rotation as illustrated in FIG. 8A.

On the other hand, when the printing position is located at either one of the ends of the spectacle lens 100, the spectacle lens 100 is rotated such that the surface 101 of the spectacle lens 100 can be held in the horizontal position as illustrated in FIGS. 8B and 8C.

By this method, the control step controls the distance between the printing position on the surface 101 of the spectacle lens 100 and the nozzle 121 such that the distance therebetween becomes substantially equal for each of the positions shown in FIGS. 8A, 8B, and 8C. As a result, the respective sizes of the first ink drops 110 contacting the surface 101 of the spectacle lens 100 become substantially equal, which prevents deformation of the shapes of the marks 102 (see FIG. 3). The control step is especially effective when the spectacle lens 100 has a small radius of curvature.

The control step may control the height of the spectacle lens 100 such that the distance (H) between the surface 101 of the spectacle lens 100 and the nozzle 121 becomes 5 mm or shorter by using the holder 123. When the height difference between the position of the spectacle lens 100 closest to the nozzle 121 such as the center of the spectacle lens 100 and the position of the spectacle lens 100 farthest from the nozzle 121 such as the ends of the spectacle lens 100 lies within a predetermined range, the control step becomes only a step which allows the position of the spectacle lens 100 closest to the nozzle 121 such as the center of the spectacle lens 100 to approach the nozzle 121 without adjustment of the inclination of the spectacle lens 100.

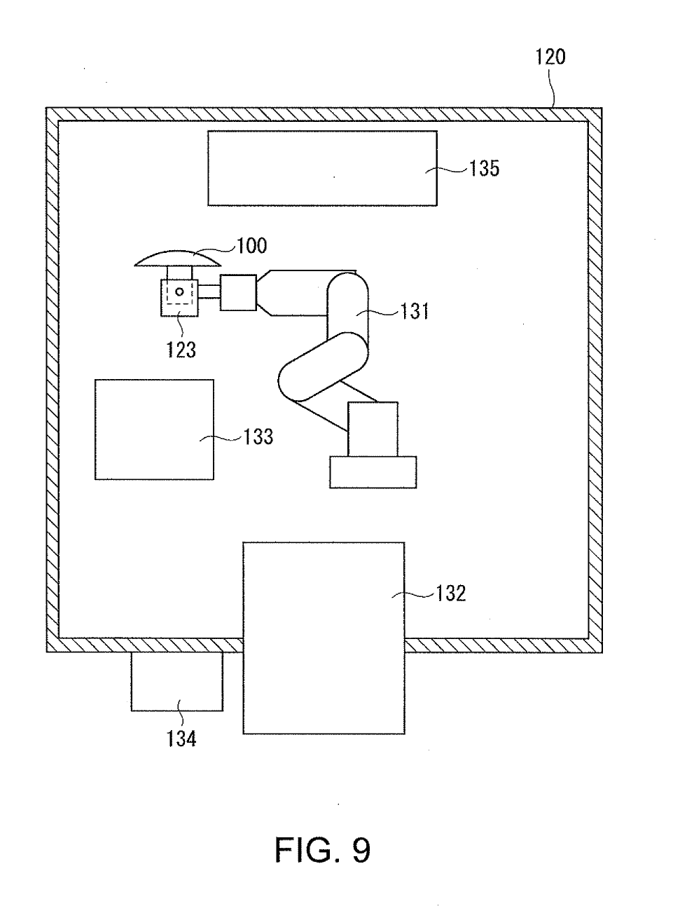

The marking method performed by a marking device 120 according to the first embodiment is now explained with reference to FIGS. 2 and 9. FIG. 9 illustrates the entire structure of the marking device 120 which executes the marking method.

The marking device 120 picks up the spectacle lens 100 prior to marking from an exchanging unit 132 by using the holder 123 provided at the end of a conveying unit 131, and conveys the spectacle lens 100 to a control unit 133, where a detecting unit 134 acquires information about the printing position and the radius of curvature of the surface 101 determined for each of the spectacle lenses 100. Then, the control unit 133 carries out the control step based on the acquired printing position information and the like (see FIGS. 8A through 8C). This step controls the height and inclination of the spectacle lens 100.

The conveying unit 131 conveys the spectacle lens 100 to a marking unit 135 after completion of the control of the inclination and height of the spectacle lens 100. The marking unit 135 having received the spectacle lens 100 executes the ejecting step by using the nozzle 121 and the driving unit 122 shown in FIG. 2, and conducts the hardening step by using the not-shown ultraviolet irradiator.

After completion of printing of the marks 102, the conveying unit 131 conveys the spectacle lens 100 to the exchanging unit 132, where the spectacle lens 100 on which the marks 102 have been printed is exchanged for the spectacle lens 100 prior to printing.

According to the first embodiment, the following advantages can be offered.

(1) According to the method in this embodiment, the plural first ink drops 110 hardened by irradiation of ultraviolet light do not easily mix with each other. In this case, the shapes of the marks 102 are not deformed even when the marks 102 are produced on the water-repellent layer of the spectacle lens 100. Thus, the marks 102 can be recognized in a preferable condition.

(2) The hardening step reduces mixture between the plural first ink drops 110. In this case, the large-sized first ink drops 110 are not produced. Accordingly, the marks 102 can be easily wiped off.

(3) When the first ink drops 110 are colored ink drops, the marks 102 having desired colors can be produced by reduction of mixture between the first ink drops 110.

(4) The plural first ink drops 110 are ejected and hardened such that the positions of the first ink drops 110 contacting the surface 101 are separated away from each other. Thus, mixture of the first ink drops 110 can be further reduced.

(5) When the printing density is set at 360 dpi or higher, the printing density of the first ink drops 110 increases, in which condition the marks 102 become easily recognizable. On the other hand, when the printing density is set at 720 dpi or lower, the positions of the first ink drops 110 contacting the surface 101 can be separated from each other with appropriate clearances therebetween. Thus, mixture between the plural first ink drops 110 can be decreased.

(6) The distance (H) between the nozzle 121 and the surface 101 of the spectacle lens 100 is set at 5 mm or shorter so as to prevent division of the respective first ink drops 110 into small parts before contact with the surface 101 of the spectacle lens 100. Accordingly, the shapes of the marks 102 are not deformed and thus can be recognized in a more preferable condition.

(7) The spectacle lens 100 and the nozzle 121 are shifted relative to each other such that the distance between the nozzle 121 and the surface 101 of the spectacle lens 100 becomes substantially uniform for the entire area of the surface 101. In this case, the sizes of the first ink drops 110 contacting the surface 101 of the spectacle lens 100 become substantially uniform regardless of the printing position, which reduces deformation of the shapes of the marks 102.

(8) The printing area is adjusted to the substantially horizontal position by rotation of the spectacle lens 100. Accordingly, mixture between the first ink drops 110 caused by flow of the first ink drops 110 to the adjacent first ink drops 110 can be avoided.

### Second Embodiment

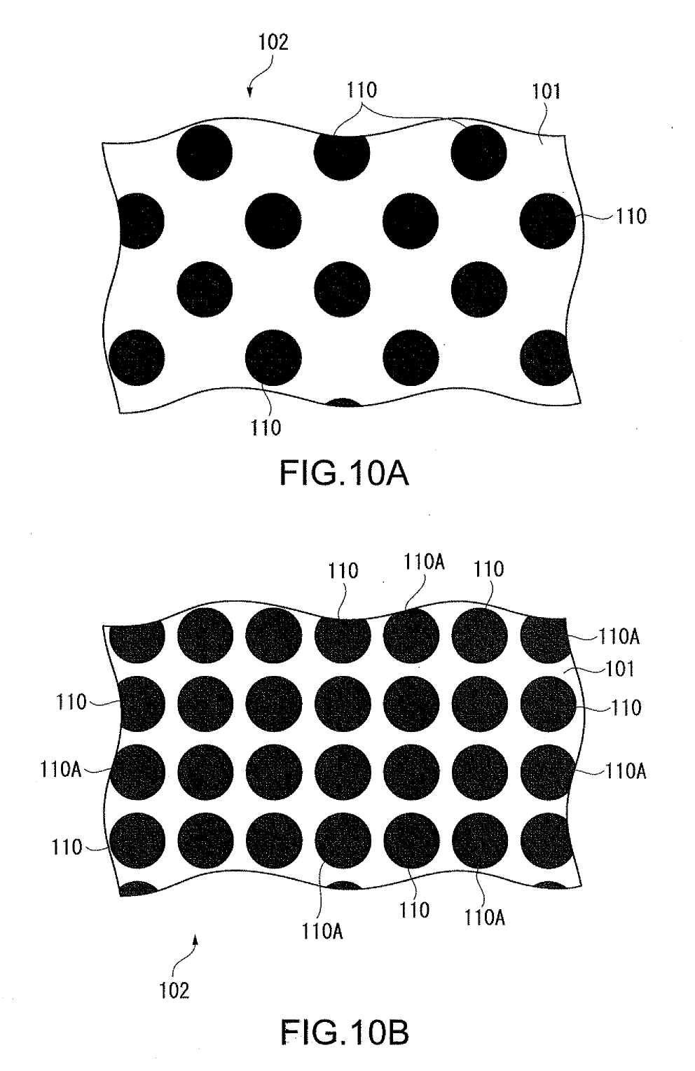

A marking method according to a second embodiment is now explained. FIGS. 10A and 10B illustrate the spectacle lens marking method according to the second embodiment.

The marking method in the second embodiment is different from the marking method in the first embodiment in that a clearance ejecting step and a clearance hardening step are added. The steps other than the clearance ejecting step and the clearance hardening step and similar to the corresponding steps in the first embodiment are explained only briefly or are not repeatedly discussed herein.

The marking method according to the second embodiment includes the ejecting step, the hardening step, the clearance ejecting step, and the clearance hardening step.

Initially, as illustrated in FIG. 10A, the plural first ink drops 110 are ejected onto the surface 101 of the spectacle lens 100 such that the positions of the first ink drops 110 contacting the surface 101 are separated from each other, whereafter the ejected first ink drops 110 are hardened on the surface 101.

Then, as illustrated in FIG. 103, additional second ink drops 110A are ejected toward the clearances between the adjoining hardened first ink drops 110 in the clearance ejecting step according to the second embodiment. After the clearance ejecting step, the second ink drops 110A are hardened to form the marks 102 in the clearance hardening step.

According to the second embodiment, the following advantages can be offered.

(9) The clearance ejecting step ejects the second ink drops 110A such that the clearances between the adjoining first ink drops 110 can be filled with the second ink drops 110A. In this case, both the printing densities of the first ink drops 110 and the second ink drops 110A increase.

Accordingly, the marks 102 become sufficiently dark and recognizable in a more preferable condition.

(10) The hardening step is executed prior to the clearance ejecting step. In this case, the first ink drops 110 ejected in the ejecting step can be hardened before execution of the clearance ejecting step. Thus, mixture between the first ink drops 110 ejected in the ejecting step and the second ink drops 110A ejected in the clearance ejecting step can be avoided.

### Modified Example

The invention is not limited to the embodiments described herein. Modifications, improvements and the like of the embodiments including the following changes may be made without departing from the scope of the invention.

For example, the marking method in the first embodiment used for the progressive-multifocal lens may be employed for producing a mark on a single-vision lens.

According to the embodiments, the spectacle lens is rotated by the holder 123. However, when the spectacle lens has a substantially flat surface, the spectacle lens need not be rotated. In this case, the first ink drops 110 can be ejected toward any position of the surface of the spectacle lens from a uniform distance in accordance with the shift of the nozzle 121 effected by the driving unit 122.

According to the second embodiment, only one drop of the second ink drops 110A is ejected between each adjoining pair of the hardened first ink drops 110 in the clearance ejecting step. However, the number of the second ink drops 110A ejected therebetween may be plural.

### EXAMPLES

The details of the invention are further described showing the following examples and comparisons. The scope of the invention is not limited to the descriptions associated with these examples.

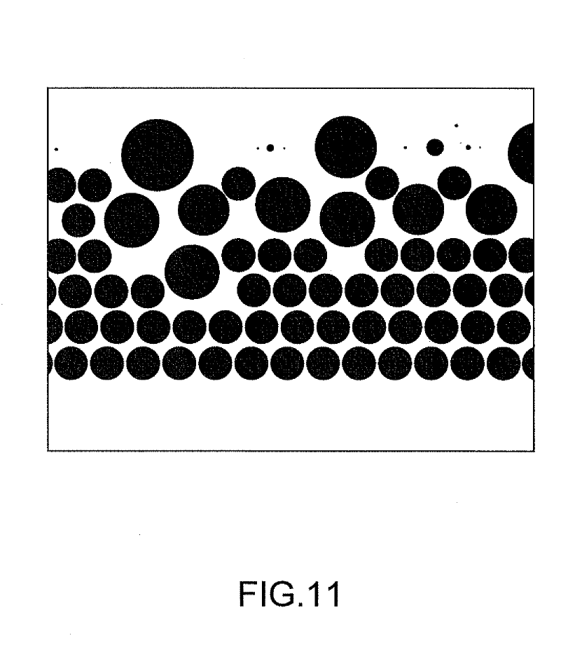

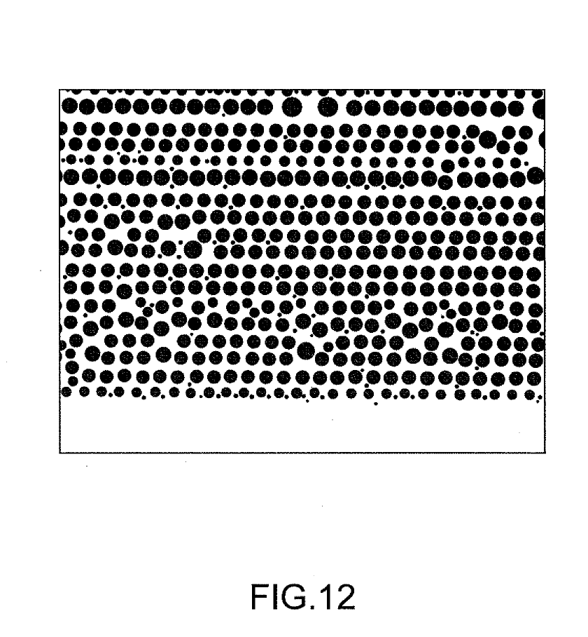

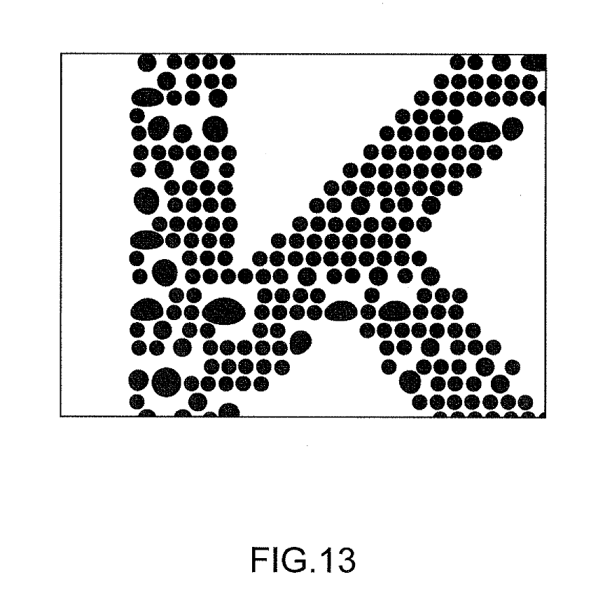

FIG. 11 illustrates first ink drops constituting a mark printed according to an example 1. FIG. 12 illustrates first ink drops constituting a mark printed according to an example 2. FIG. 13 illustrates first ink drops and second ink drops constituting a mark printed according to an example 3.

### Example 1

The marking method performed in the example 1 corresponds to the marking method in the first embodiment. More specifically, the mark is produced by using the nozzle providing the printing density of 360 dpi and ejecting the first ink drops such that the positions of the first ink drops contacting the surface of the spectacle lens can be separated from each other. FIG. 11 is an enlarged view of the mark thus printed.

### Example 2

The example 2 is different from the example 1 in that the 360 dpi nozzle modified in the manner described in the first embodiment is used to produce the mark. FIG. 12 is an enlarged view of the mark thus printed.

### Example 3

The marking method performed in the example 3 corresponds to the marking method in the second embodiment. The nozzle used in this example is the modified 360 dpi nozzle similarly to the example 2.

More specifically, the first ink drops are ejected from the modified 360 dpi nozzle such that the positions of the first ink drops contacting the surface of the spectacle lens can be separated from each other, and hardened at the respective positions (ejecting step and hardening step).

Then, the second ink drops are additionally ejected from the same modified type nozzle toward the clearances between the adjoining hardened first ink drops, and hardened thereat (the clearance ejecting step and clearance hardening step). As a result, the mark is produced on the surface of the spectacle lens. FIG. 13 illustrates the enlarged view of the mark thus printed.

According to the examples 1 through 3, the clearances are provided between the adjoining first ink drops. In this case, mixture of the first ink drops decreases. It is therefore confirmed that the mark thus produced can be recognized in a preferable condition.

Particularly in the example 3, both the printing densities of the first ink drops and the second ink drops increase. Accordingly, it is confirmed that the mark thus printed can be recognized in a preferable condition.

What is claimed is:

1. A spectacle lens marking method, comprising:
ejecting a first ink drop of ultraviolet curable ink from a nozzle by ink jet system onto a surface of a water-repellent layer provided on a surface of the spectacle lens; and
hardening the first ink drop by applying ultraviolet light to the first ink drop.

2. The spectacle lens marking method according to claim 1, wherein:
a plurality of the first ink drops are ejected such that the positions of the first ink drops contacting the surface of the spectacle lens can be separated from each other; and
the plurality of the first ink drops ejected on the surface of the lens are hardened before contacting each other.

3. The spectacle lens marking method according to claim 2, further comprising:
ejecting a second ink drop from the nozzle toward a position between the plural hardened first ink drops; and
hardening the second ink drop by applying ultraviolet light to the second ink drop.

4. The spectacle lens marking method according to claim 2, wherein the printing density of the first ink drops lies in a range from 360 dpi to 720 dpi.

5. The spectacle lens marking method according to claim 2, wherein the first ink drops are ejected in such a condition that the distance between the nozzle and the surface of the spectacle lens becomes 5 mm or shorter.

6. The spectacle lens marking method according to claim 2, wherein:
the surface of the spectacle lens is a curved surface; and
the spectacle lens marking method further includes shifting the nozzle and the spectacle lens relative to each other in the radial direction of the spectacle lens such that the distance between the surface of the spectacle lens and the nozzle becomes uniform.
